(19) United States
(12) Patent Application Publication
(10) Pub. No.: US 2001/0035479 A1
(43) Pub. Date: Nov. 1, 2001

(54) Ergonomic pointing device stand

(76) Inventor: James D. Roebuck, Mesa, AZ (US)

Correspondence Address: S. Jared Pitts, Schmeiser, Olsen & Watts LLP, 18 East University Drive, #101, Mesa, AZ, 85201, US

(21) Appl. No.: 09/809,374

(22) Filed: Mar. 15, 2001

Related U.S. Application Data
(60) Provisional application No. 60/197,315, filed on Apr. 14, 2000.

(51) Int. Cl. A47F 5/00; A47F 7/00; F16M 11/00; F16M 13/00

(52) U.S. Cl. 248/125.1; 248/918; 248/910

(57) ABSTRACT

The preferred embodiment of the present invention provides a an ergonomic pointing device stand that has the flexibility to provide an ergonomic environment for using pointing devices that can be adapted to a wide variety of users in a wide variety of applications. The pointing device stand of the preferred embodiment includes an upright stand with a weighted base and a telescoping vertical support; the upright stand including an upper pivoting plate for attaching and using a pointing device. In one embodiment, a hook and pile fastener pad is provided at a top end of the vertical support thereon that is securable to the bottom of a trackball using a companionate hook and pile fastener. In another embodiment, a mouse platform having a companionate hook and pile fastener provided thereon.

### BACKGROUND OF THE INVENTION

1. Technical Field

The present invention relates to computer accessories and more particularly to a pointing devices used to commonly control computer operation

2. Background Art

Recently there has been increased recognition of the role that proper ergonomics plays in making work more comfortable and improving both health and productivity. Discomfort and fatigue resulting from poor ergonomic design, whether personal or work-related, can cut into productivity, and when left unattended, can result in injury or even complete or partial debilitation.

One group of users that suffers considerably from poor ergonomics are those that operate computers for extended periods of time. Computers are found in many aspects of our lives: work, education and recreation. As a result, a large portions of our population now regularly use computers for extended periods of time. While the physical stresses required to use keyboards and pointing devices and to look at video display units are relatively low, they may be maintained for extended periods of time, and thus are commonly the cause of ergonomic related health problems.

One of the more difficult areas to achieve proper ergonomics is in use of computer pointing devices. Computer pointing devices, such as mice and trackballs, are commonly used to operate the graphical user interface of modem computers. It is often difficult for individuals using computers to have the mouse or trackball of the computer positioned at a desired height and angle. For example, left-handed individuals sitting at a desk designed for right-handed people might not have enough space to comfortably operate a mouse or trackball. Or, for example, an individual in the midst of a big project may prefer to remove the mouse or trackball from the desktop to make more desk space for papers. Or, for example an individual operating a lap-top computer may prefer to use a separate mouse or trackball, but may not be sitting at a desk at all. Unfortunately, there are currently no pointing device solutions that have the flexibility and ergonomic features that are needed to meet the needs of the many current and future users of computers.

### SUMMARY OF INVENTION

Accordingly, the preferred embodiment of the present invention provides a an ergonomic pointing device stand that has the flexibility to provide an ergonomic environment for using pointing devices that can be adapted to a wide variety of users in a wide variety of applications. The pointing device stand of the preferred embodiment includes an upright stand with a weighted base and a telescoping vertical support; the upright stand including an upper pivoting plate for attaching and using a pointing device. In one embodiment, a hook and pile fastener pad is provided at a top end of the vertical support thereon that is securable to the bottom of a trackball using a companionate hook and pile fastener. In another embodiment, a mouse platform having a companionate hook and pile fastener provided thereon. Because the pointing device stand is used independent of any other furniture, it can be easily placed in any suitable location, and adjusted for a wide variety of uses. Thus, it does not suffer from the limitation of prior support devices, which were attached directly to other furniture and thus were limited in location and adjustment.

The foregoing and other features and advantages of the invention will be apparent from the following more particular description of preferred embodiments of the invention, as illustrated in the accompanying drawings.

### BRIEF DESCRIPTION OF THE DRAWINGS

The preferred embodiments of the present invention will hereinafter be described in conjunction with the appended drawings, where like designations denote like elements.

FIG. 1 is a side view of a preferred embodiment of the present invention illustrating the pointing device;

FIG. 2 is a side view of a preferred embodiment of the present invention illustrating the pointing device stand as it may be used to support a trackball; and

FIG. 3 is a side view of a preferred embodiment of the present invention illustrating the pointing device stand as it may be used to support a mouse.

### MODES OF CARRYING OUT THE INVENTION

The preferred embodiment of the present invention provides an ergonomic pointing device stand that has the flexibility to provide an ergonomic environment for using pointing devices that can be adapted to a wide variety of users in a wide variety of applications. The pointing device stand of the preferred embodiment includes an upright stand with a weighted base and a telescoping vertical support; the upright stand including an upper pivoting plate for attaching and using a pointing device. In one embodiment, a hook and pile fastener pad is provided at a top end of the vertical support thereon that is securable to the bottom of a trackball using a companionate hook and pile fastener. In another embodiment, a mouse platform having a companionate hook and pile fastener provided thereon. Because the pointing device stand is used independent of any other furniture, it can be easily placed in any suitable location, and adjusted for a wide variety of uses. Thus, it does not suffer from the limitation of prior support devices, which were attached directly to other furniture and thus were limited in location and adjustment.

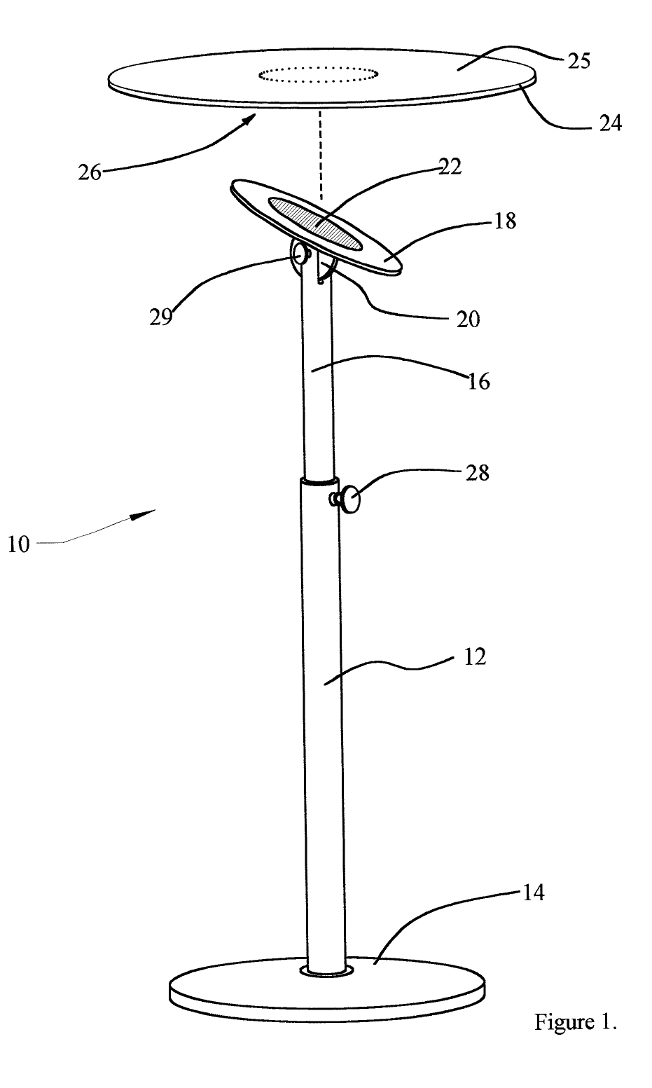

FIG. 1 shows an exemplary embodiment of the present invention pointing device stand generally designated 10. Ergonomic pointing device stand 10 includes an upright stand 12 including a weighted base 14 and a telescoping vertical support 16. A top end 18 of telescoping vertical support 16 includes a pivoting joint 20 and hook and pile fastener section 22 that is used for attaching to any desirable pointing device having a companionate section of hook and pile fastener material provided on the bottom thereof. For example, the hook and pile fastener section 22 can be used with a companionate hook and pile fastener to attach to a trackball, a joystick, a pen tablet, or mouse platform such as mouse platform 24.

FIG. 1 illustrates that the telescoping vertical support 16 is contained within upright stand 12 and can move slidingly within upright stand 12. When telescoping vertical support 16 is extended up, upright stand 12 is raised. The telescoping vertical support 16 can then be locked in place at the desired height by being clamped in place by set screw 28. In addition, FIG. 1 illustrates that the pivoting joint 20 at the top of telescoping vertical support 16 can be locked at a preferred angle by set screw 29.

FIG. 1 also illustrates that mouse platform 24 is shaped to be useful for supporting a computer mouse. Top surface 25 of mouse platform 24 can be any surface suitable for operating a computer mouse including fabric, fabric covered foam, glass, laminate material or other well-known materials for supporting a computer mouse.

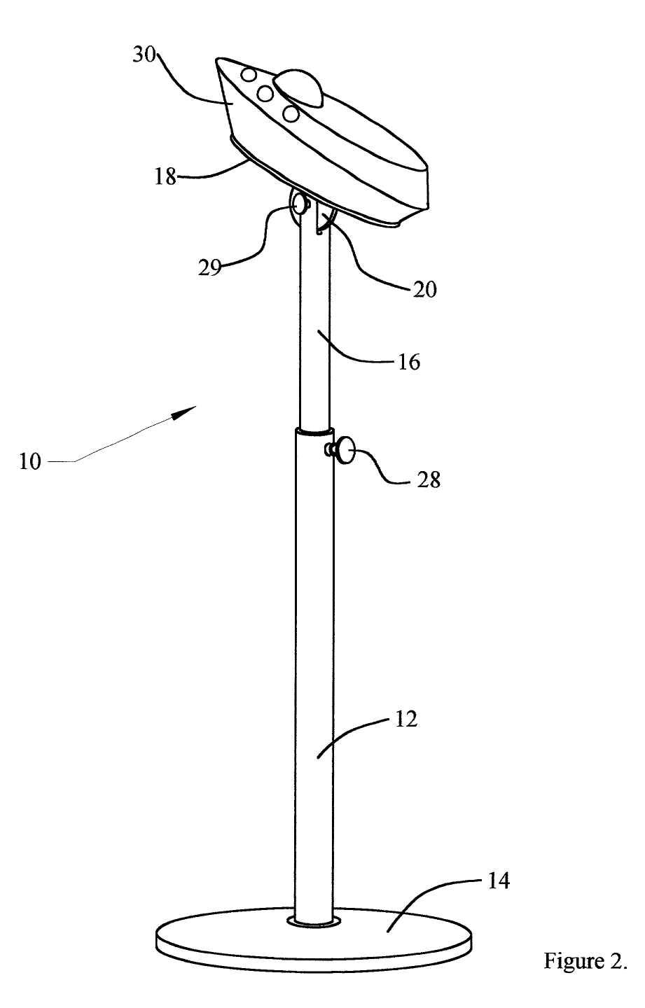

Turning now to FIG. 2, FIG. 2 illustrates an exemplary embodiment of the present invention ergonomic pointing device stand generally designated 10, when used with a trackball 30. Ergonomic pointing device stand 10 includes an upright stand 12 including a weighted base 14 and a telescoping vertical support 16. A top end 18 of telescoping vertical support 16 includes a pivoting joint 20 and a hook and pile fastener section 22 that is used for attaching the trackball 30 having a companionate section of hook and pile fastener material 26. Of course, other types of pointing devices, such as a pen tablets, joysticks, etc., could also be used with the pointing device stand illustrated in FIG. 2. By providing the trackball on the pointing device stand 10, the present invention provides the user with the ability to move the trackball area to any location that is ergonomically desirable, without regards for the location and structure of existing furniture.

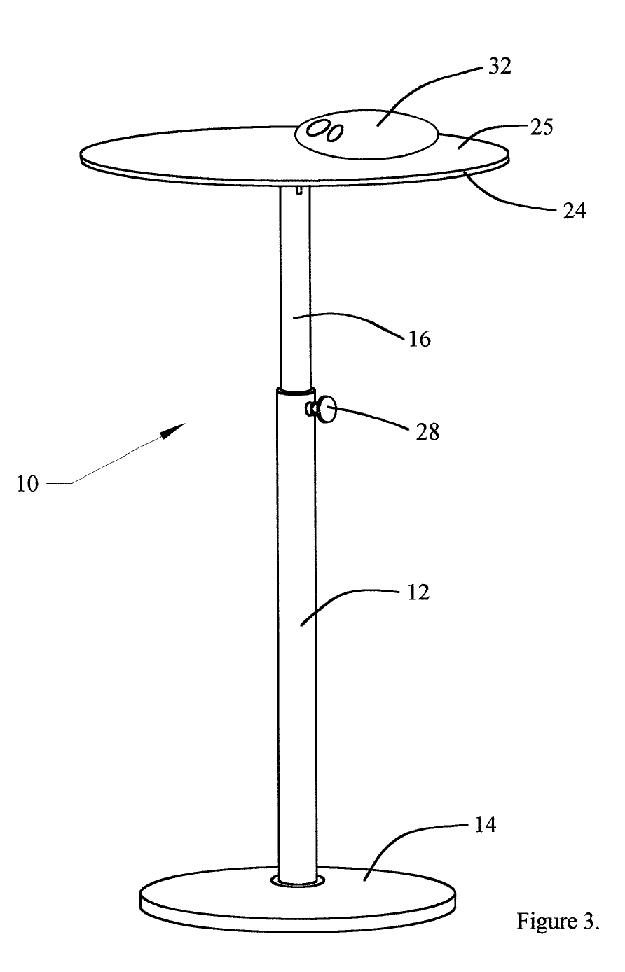

Turning now to FIG. 3, FIG. 3 illustrates an exemplary embodiment of the present invention ergonomic pointing device stand generally designated 10, when used with a mouse platform 24. Ergonomic pointing device stand 10 includes an upright stand 12 including a weighted base 14 and a telescoping vertical support 16. A top end 18 of telescoping vertical support 16 includes a pivoting joint 20 and is attached to the mouse platform 24. The mouse platform 24 provides an area in which the mouse 32 can be efficiently operated. By providing the mouse platform 25 on the pointing device stand 10, the present invention provides the user with the ability to move the mouse operational area to any location that is ergonomically desirable, without regards for the location and structure of existing furniture.

Thus, the embodiments of the present invention provide an ergonomic pointing device stand that has the flexibility to provide an ergonomic environment for using pointing devices that can be adapted to a wide variety of users in a wide variety of applications. Because the pointing device stand is used independent of any other furniture, it can be easily placed in any suitable location, and adjusted for a wide variety of uses. Thus, it does not suffer from the limitation of prior support devices, which were attached directly to other furniture and thus were limited in location and adjustment.

It is noted that the embodiment of the ergonomic pointing device stand described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

While the invention has been particularly shown and described with reference to preferred embodiments thereof, it will be understood by those skilled in the art that various changes in form and details may be made therein without departing from the spirit and scope of the invention.

1. An adjustable stand for supporting a computer pointing device, the adjustable stand comprising:
a weighted base;
an adjustable vertical support; and
a plate, the plate pivotally connected to the adjustable vertical support, wherein said plate comprises a top surface and an attachment mechanism for attaching a pointing device.

2. The adjustable stand of claim 1 wherein the attachment mechanism comprises a hook and pile fastener pad affixed to said top surface.

3. The adjustable stand of claim 2 further comprising a mouse platform having a top surface and a bottom surface, the mouse platform attaching to the plate top surface, the mouse platform providing an area to operate a computer mouse.

4. The adjustable stand of claim 3 wherein said mouse platform bottom surface comprises a companionate hook and pile fastener pad structured and arranged to adhere to the hook and pile fastener pad affixed to said top surface of said adjustable stand.

5. The adjustable stand of claim 2 further comprising a trackball having a trackball bottom surface and having a companionate hook and pile fastener pad affixed to the trackball bottom surface.

6. An adjustable pointing device stand, the adjustable pointing device stand comprising:
a weighted base, the weighted base having a bottom surface for placing on the ground;
a telescoping vertical support, the telescoping vertical support having a bottom attached to the weighted base and a top;
a pivoting joint, the pivoting jointed connected to the top of the telescoping vertical support; and
an attachment mechanism coupled the pivoting joint, the attachment mechanism structured and arranged to receive the pointing device.

7. The adjustable stand of claim 6 wherein the attachment mechanism comprises a hook and pile fastener for coupling to the pointing device.

8. The adjustable stand of claim 6 further comprising a mouse platform, the mouse platform coupled to the attachment mechanism and providing an area for operating a computer mouse.

9. The adjustable stand of claim 6 wherein the pointing device comprises a trackball.

10. The adjustable stand of claim 6 wherein the telescoping vertical support further comprises a locking device for locking the telescoping vertical support at a selected height.

11. An adjustable pointing device stand, the adjustable pointing device stand comprising:
a weighted base, the weighted base having a flat bottom surface for placing on the ground;
a telescoping vertical support, the telescoping vertical support having a bottom attached to the weighted base and a top;
a locking mechanism for locking the telescoping vertical support at a selected height
a pivoting joint having a top surface , the pivoting jointed connected to the top of the telescoping vertical support; and
an hook and pile fastener coupled to the top surface of the pivoting joint, the hook and pile fastener provided to attach to and hold a pointing device.

12. The adjustable stand of claim 11 further comprising a mouse platform, the mouse platform having a companion hook and pile fastener for coupling to the hook and pile fastener on the top surface of the pivoting joint, the mouse platform providing an area for operating a computer mouse.

13. The adjustable stand of claim 11 wherein the pointing device comprises a trackball, wherein the trackball has a companion hook and pile fastener for coupling to the hook and pile fastener on the top surface of the pivoting joint.
